(19) United States
(12) Patent Application Publication
(10) Pub. No.: US 2026/0203957 A1
(43) Pub. Date: Jul. 16, 2026

(54) METHOD AND APPARATUS FOR ENCODING/DECODING FEATURE MAP USING SELECTIVE LEARNING TECHNIQUE AND ADAPTIVE CHANNEL TRUNCATION

(71) Applicants: Electronics and Telecommunications Research Institute, Daejeon (KR); INDUSTRY-UNIVERSITY COOPERATION FOUNDATION KOREA AEROSPACE UNIVERSITY, Goyang-si (KR)

(72) Inventors: Se Yoon JEONG, Daejeon (KR); Youn Hee KIM, Daejeon (KR); JooYoung LEE, Daejeon (KR); Jung Won KANG, Daejeon (KR); Jae Gon KIM, Daejeon (KR); Gyu Woong HAN, Daejeon (KR); In Keun YOO, Daejeon (KR)

(73) Assignees: Electronics and Telecommunications Research Institute, Daejeon (KR); INDUSTRY-UNIVERSITY COOPERATION FOUNDATION KOREA AEROSPACE UNIVERSITY, Goyang-si (KR)

(21) Appl. No.: 19/368,523

(22) Filed: Oct. 24, 2025

(30) Foreign Application Priority Data
Oct. 25, 2024 (KR) 10-2024-0147949
Jan. 8, 2025 (KR) 10-2025-0003075
Jun. 20, 2025 (KR) 10-2025-0081853

(51) Int. Cl. G06T 9/00; G06T 11/00

(52) U.S. Cl. CPC G06T 9/002; G06T 11/00

(57) ABSTRACT

A feature map encoding device of the present disclosure may include a feature reduction unit including a first artificial neural network that removes redundancy of a multi-layer feature map to output a single-layer feature map, a feature conversion unit that converts the single-layer feature map according to an input format of a signal processing-based encoder to generate a YUV frame, and a feature inner coding unit including the signal processing-based encoder that encodes the YUV frame to output a bitstream.

### CROSS-REFERENCE TO RELATED APPLICATIONS

This application claims the benefit of earlier filing date and right of priority to Korean Application No. 10-2024-0147949, filed on Oct. 25, 2024, Korean Application No. 10-2025-0003075, filed on Jan. 8, 2025, and Korean Application No. 10-2025-0081853, filed on Jun. 20, 2025, the contents of which are all hereby incorporated by reference herein in their entirety.

### TECHNICAL FIELD

The present disclosure may be utilized in the technical fields of an artificial neural network and signal processing-based encoding/decoding.

In particular, the present disclosure may relate to a technology for minimizing the performance degradation of machine tasks performed by using a decoded feature map while reducing the compression bit amount of a feature map by providing a method for encoding a feature map extracted from a machine task artificial neural network through the combination of an artificial neural network and a signal processing-based encoding/decoding method.

### BACKGROUND ART

In the existing method for combining an artificial neural network and signal processing-based encoding, an artificial neural network performs only simple format conversion on an output feature map in which the redundancy of an input multi-layer feature map is reduced and uses it as a signal processing-based encoder input. The existing method for performing simple format conversion may not be an optimal method in terms of rate-control optimization.

### DISCLOSURE

### Technical Problem

In the existing method for combining an artificial neural network and signal processing-based encoding, the present disclosure proposes a method for applying a selective learning technique to an artificial neural network learning process to align the output feature map order in the order of importance contributing to performance as well as the redundancy of an input multi-layer feature map in order to enhance the performance of performing only simple format conversion in a part where an artificial neural network and signal processing-based encoding are combined.

The present disclosure may have a characteristic that an artificial neural network learned by using a selective learning technique outputs a feature map aligned in the order of performance contribution importance and redundancy removal of an input multi-layer feature map. Because an output feature map is aligned, a feature map may be truncated and delivered as much as desired by considering a target bit rate and importance in a signal processing-based encoder input conversion process, improving encoding performance.

### Technical Solution

A feature map encoding device of the present disclosure may include a feature reduction unit including a first artificial neural network that removes redundancy of a multi-layer feature map to output a single-layer feature map, a feature conversion unit that converts the single-layer feature map according to an input format of a signal processing-based encoder to generate a YUV frame, and a feature inner coding unit including the signal processing-based encoder that encodes the YUV frame to output a bitstream.

A feature map decoding device of the present disclosure may include a feature inner coding unit including a signal processing-based decoder that decodes a bitstream to obtain a restored YUV frame, a feature inverse conversion unit that inversely converts the restored YUV frame to obtain an inversely converted single-layer feature map, and a feature restoration unit including a second artificial neural network that outputs a restored multi-layer feature map from the inversely converted single-layer feature map.

In the feature map encoding/decoding device, method and recording medium of the present disclosure, a selective learning strategy may be applied to the first artificial neural network.

In the feature map encoding/decoding device, method and recording medium of the present disclosure, when the selective learning strategy is applied, the first artificial neural network may include a channel masking block, and the channel masking block may activate or deactivate channels of a feature map through masking.

In the feature map encoding/decoding device, method and recording medium of the present disclosure, a range of a channel aligned by the selective learning strategy may be adjusted by a masking adjustment variable n.

In the feature map encoding/decoding device, method and recording medium of the present disclosure, a range of a channel aligned by the selective learning strategy may be adjusted dynamically when the selective learning strategy progresses.

In the feature map encoding/decoding device, method and recording medium of the present disclosure, a part of masked channels output by a channel masking block of the first artificial neural network may be truncated by a first truncation block.

In the feature map encoding/decoding device, method and recording medium of the present disclosure, a degree of the truncation may be determined differently according to a quantization parameter of the first artificial neural network.

In the feature map encoding/decoding device, method and recording medium of the present disclosure, learning of the first artificial neural network may be performed based on a loss function including a first learning term for a rate and a second learning term for distortion.

In the feature map encoding/decoding device, method and recording medium of the present disclosure, the same mask element as used in the second learning term may be applied to the first learning term.

In the feature map encoding/decoding device, method and recording medium of the present disclosure, the loss function may be calculated by cumulative averaging a loss value calculated at each quality level, and the number of the quality levels may be different according to a dataset.

In the feature map encoding/decoding device, method and recording medium of the present disclosure, a threshold that serves as a criterion for the activation or deactivation may be determined differently according to a quantization parameter of a first artificial neural network, and the threshold may be determined by using an average entropy value of the channels.

In the feature map encoding/decoding device, method and recording medium of the present disclosure, the activated or deactivated channels may be divided into three sections and signaled in a bitstream.

### Technical Effect

The present disclosure may perform output in the order of importance contributing to performance simultaneously with effectively reducing the inter-layer redundancy of an input multi-layer feature map, and based on this, perform truncation and delivery as many as necessary channels by considering a bit rate in a signal processing-based encoder input conversion process, improving encoding performance.

### BRIEF DESCRIPTION OF DRAWINGS

FIG. 1 illustrates an embodiment of a feature map compression encoding/decoding processing process (pipeline).

FIG. 2 illustrates an embodiment of the structure and input/output of FCTM, which is FCM reference software.

FIG. 3 illustrates an embodiment of the structure and input/output of a feature map encoding/decoding method to which the selective learning strategy and adaptive truncation method of the present disclosure are applied.

FIG. 4 illustrates an embodiment in which a selective learning strategy is applied to FCTM Step 1 learning.

FIG. 5 is a diagram for describing channel masking.

FIG. 6 illustrates an embodiment of a channel aligned through SLS.

FIG. 7 illustrates an embodiment in which an alignment range is adjusted early in a channel output from SLS.

FIG. 8 is another embodiment of SLS and illustrates a method for dynamically adjusting an alignment range during a learning process.

FIG. 9 illustrates an example of coding for a method for dynamically adjusting an alignment range during a learning process.

FIG. 10 is a diagram for describing the effect of embodiments in which SLS strength is adjusted early.

FIG. 11 illustrates an embodiment of adaptive truncation.

FIG. 12 illustrates an example of the number of activated channels for each quality level.

FIG. 13 illustrates an embodiment in which a channel unit feature removal technique is applied.

FIG. 14 is a diagram for describing the effect of applying RBICR.

FIG. 15 is a diagram for describing the QA-RBICR technology using entropy.

FIG. 16 illustrates an embodiment representing whether a channel is activated.

FIG. 17 illustrates an example in which a channel number section is divided.

### MODE FOR INVENTION

The present invention may be variously changed, and may have various embodiments, and specific embodiments will be described in detail below with reference to the attached drawings. However, it should be understood that those embodiments are not intended to limit the present invention to specific disclosure forms, and that they include all changes, equivalents or modifications included in the spirit and scope of the present invention. In the drawings, similar reference numerals are used to designate the same or similar functions in various aspects. The shapes, sizes, etc. of components in the drawings may be exaggerated to make the description clear. Detailed descriptions of the following exemplary embodiments will be made with reference to the attached drawings illustrating specific embodiments. These embodiments are described so that those having ordinary knowledge in the technical field to which the present disclosure pertains can easily practice the embodiments. It should be noted that the various embodiments are different from each other, but do not need to be mutually exclusive of each other. For example, specific shapes, structures, and characteristics described here may be implemented as other embodiments without departing from the spirit and scope of the embodiments in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as long as they are appropriately described.

Terms such as “first” and “second” may be used to describe various components, but the components are not restricted by the terms. The terms are used only to distinguish one component from other components. For example, the first component may be named the second component without departing from the scope of the right of the present disclosure and likewise, the second component may be named the first component. The terms “and/or” may include combinations of a plurality of related described items or any of a plurality of related described items.

It will be understood that when a component in the present disclosure is referred to as being “connected” or “coupled” to another component, it may be directly connected or coupled to such another component, but another component also may exist in the middle. On the other hand, it will be understood that when a component is referred to as being “directly connected or coupled”, another component does not exist in the middle.

As construction units shown in an embodiment of the present disclosure are independently shown to represent different characteristic functions, it does not mean that each construction unit is composed in a construction unit of separate hardware or one software. In other words, construction units are included by being arranged as a construction unit for convenience of a description, and at least two of the construction units may be integrated into one construction unit, or one construction unit may be divided into a plurality of construction units to perform a functions, and the integrated embodiment and the separated embodiment of each construction unit are also included in the scope of the right of the present disclosure as long as they do not depart from the essence of the present disclosure.

The terms used in the present disclosure are merely used to describe specific embodiments, and are not intended to limit the present disclosure. A singular expression includes a plural expression unless the context clearly indicates otherwise. In the present disclosure, it should be understood that terms such as “include” or “have” are merely intended to indicate that features, numbers, steps, operations, components, parts described herein or combinations thereof are present, and are not intended to exclude the possibility in advance that one or more other features, numbers, steps, operations, components, parts or combinations thereof are present or added. In other words, a description of “including” a specific configuration does not exclude a configuration other than a corresponding configuration, and means that an additional configuration may be included in the scope of the technical idea of the present disclosure or the embodiment of the present disclosure.

Some components of the present disclosure are not an essential component for performing an essential function in the present disclosure, but may be merely an optional component for improving performance. The present disclosure may be implemented by including only construction units essential for implementing the essence of the present disclosure excluding components used only for performance improvement, and a structure including only essential components excluding optional components used only for performance improvement is also included in the scope of the right of the present disclosure.

Hereinafter, the embodiments of the present disclosure will be described in detail below by referring to drawings. In describing the embodiments of the present disclosure, when it is determined that a specific description for related known configurations or functions may obscure the gist of the present disclosure, that detailed description is omitted, and the same reference numerals are used for the same components on drawings and a repeated description for the same components is omitted.

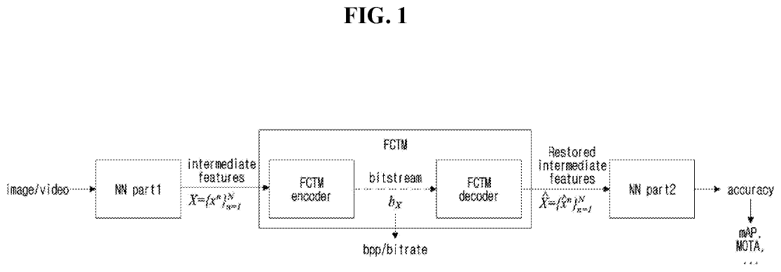

FIG. 1 illustrates an embodiment of a feature map compression encoding/decoding processing process (pipeline).

FCM (Feature Coding for Machines) is a technology for compressing and restoring a feature map and an FCTM (Feature Compression Test Model) may be a model implemented by software.

Referring to FIG. 1, the feature map compression encoding/decoding processing process of the present disclosure may include at least one of NN part 1 (Neural Network part 1) for extracting a feature map from a neural network, an FCTM encoder for encoding a feature map into a bitstream, an FCTM decoder for decoding a feature map from a bitstream or NN part 2 (Neural Network part 2) for processing a computer vision task by utilizing a feature map.

In other words, an FCTM may be intended to smoothly perform computer vision processing in NN part 2 simultaneously with reducing the transmission cost of a bitstream by encoding/decoding a feature map extracted from NN part 1 (an analysis network) in the pipeline of FIG. 1.

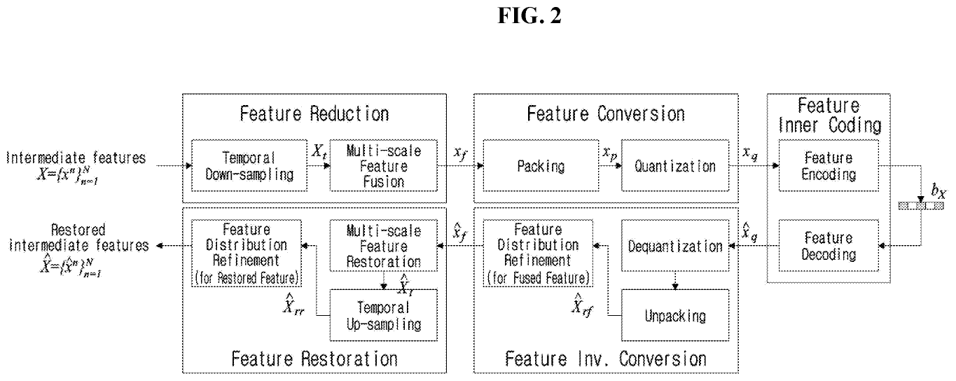

FIG. 2 illustrates an embodiment of the structure and input/output of FCTM, which is FCM reference software.

Referring to FIG. 2, the feature reduction unit may be a unit including an artificial neural network (FENet (Feature Fusion and Encoding Network); a Multi-scale Feature Fusion block in FIG. 2) that outputs a single-layer feature map by removing the redundancy of an input multi-layer feature map (or, referred to as a feature map).

The feature conversion unit may convert an output single-layer feature map into a YUV 400 10-bit format to match the input format of a signal processing-based encoder (VVC Encoder). In this case, an output single-layer feature map may be tiled in a channel unit and packed into a YUV frame.

The feature inner coding unit may be composed of a signal processing-based encoder and decoder. An encoder may compress an input YUV frame by using a signal processing-based encoder to output a compressed bitstream. A decoder may decode a compressed bitstream by using a signal processing-based decoder to output a decoded YUV frame.

The feature inverse conversion unit may convert a YUV frame output by a VVC decoder into a feature map format for each frame.

The feature restoration unit may be a unit including an artificial neural network (DRNet(Feature Decoding and Reconstruction Network); a Multi-scale Feature Restoration block in FIG. 2) that outputs a decoded single-layer feature map as a multi-layer feature map.

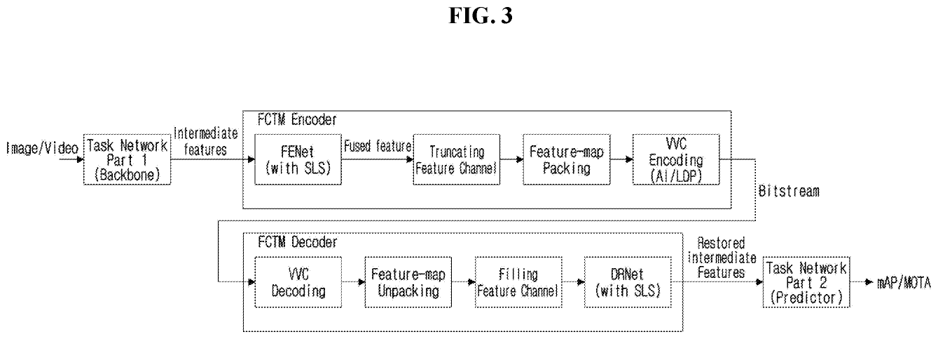

FIG. 3 illustrates an embodiment of the structure and input/output of a feature map encoding/decoding method to which the selective learning strategy and adaptive truncation method of the present disclosure are applied.

The FENet (with SLS) block of FIG. 3 may be a block that has a structure based on the FENet of FIG. 2 and applies a selective learning strategy (SLS). In other words, an FENet (with SLS) block may be an FENet block that uses SLS learning to ensure that a channel is aligned and output in the order of performance importance during an FENet learning process.

The truncating feature channel block of FIG. 3 is an embodiment of an adaptive truncation method, and may provide a function to improve encoding performance by reducing (truncating) the number of feature map channels in the order of less importance considering a target bit rate since a single-layer feature map output from FENet is aligned in the order of performance importance.

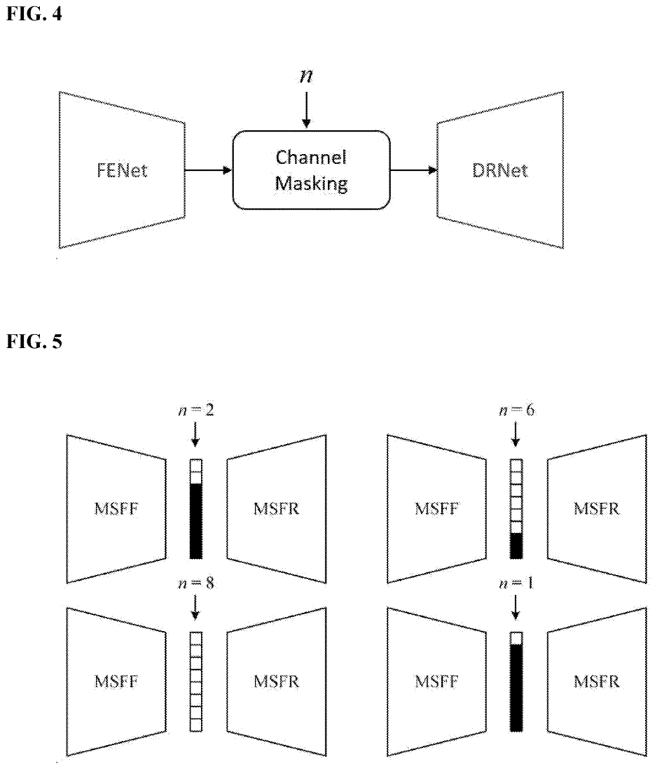

FIG. 4 illustrates an embodiment in which a selective learning strategy is applied to FCTM Step 1 learning.

The FENet and DRNet of an FCTM may be learned in an end-to-end (E2E) manner.

The FCTM learning of the present disclosure may be divided into Step 1 learning and Step 2 learning.

Referring to FIG. 4, Step 1 FCTM learning of the present disclosure may be performed under a structure composed of only an artificial neural network without a signal processing-based encoder and decoder. In this case, when a selective learning strategy (SLS) is applied, a channel masking block may be added, and when a selective learning strategy is not applied, a channel masking block may be omitted.

Whether a selective learning strategy is applied may be pre-defined, or may be determined explicitly by a flag, or may be determined implicitly by feature map information (the number of channels, a feature, etc.). As an example, a selective learning strategy may be pre-defined as being always applied.

Step 2 FCTM learning of the present disclosure may be performed by fine-tuning only DRNet under a structure in which a signal processing-based encoder/decoder is combined as shown in FIG. 2 after Step 1 FCTM learning. Step 2 learning of the present disclosure may be performed by utilizing the existing Step 2 learning technologies.

In summary, a selective learning strategy (SLS) is applied during the Step 1 learning process, and may mean that a channel masking block is added to Step 1 learning as shown in FIG. 4.

The SLS of the present disclosure may adjust masking based on masking degree adjustment variable n during a learning process to ensure that only a part of the output channels of an FENet is delivered to a DRNet.

FIG. 5 is a diagram for describing channel masking.

In the channel masking process of FIG. 5, n may be a masking degree adjustment variable (or a uniform distribution random variable). n may be a natural number such as 1, 2, 3, 4, etc. n may be a value explicitly signaled from a bitstream, a pre-defined value or a value implicitly determined by other information.

In a channel masking process, channels x_{f} with a fused feature may be masked by masking degree adjustment variable n. According to the masking, channels from 0 to (n−1) may be activated, and the remaining channels may be masked to 0 and deactivated. The masked fused feature x_{f}^{m} output in a channel masking process may be input to a DRnet.

In other words, FIG. 5 may illustrate an example in which when the number of output channels of an FENet is 8 and masking adjustment variable n is 2, only 2 of 8 channels are delivered to a DRNet (an MSFR in FIG. 5), an example in which when n is 6, only 6 of 8 channels are delivered to a DRNet, an example in which when n is 8, all of the 8 channels are delivered to a DRNet and an example in which when n is 1, only 1 of 8 channels is delivered to a DRNet.

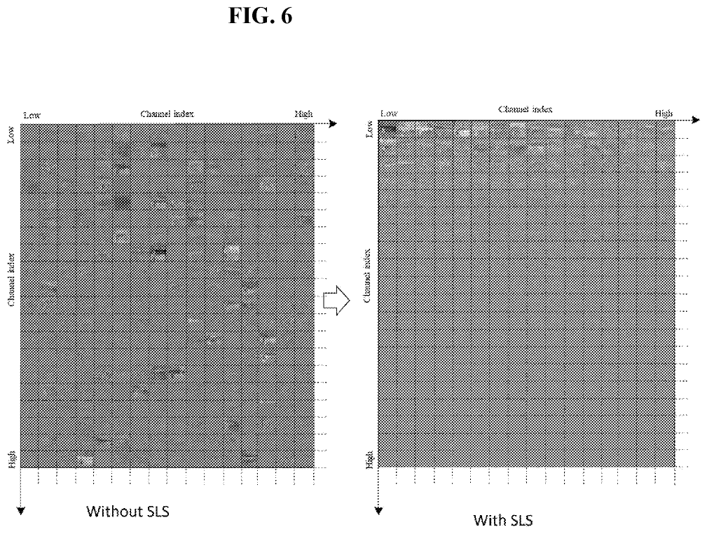

FIG. 6 illustrates an embodiment of a channel aligned through SLS.

Specifically, FIG. 6 compares an embodiment of a channel map to which SLS learning not applied with an embodiment of a channel map to which SLS learning is applied.

When the frequency of n is adjusted as a uniform distribution random variable, the output channel of an FENet (an MSFF in FIG. 5) may be aligned in the order of importance. The effects of SLS learning may be confirmed through FIG. 6.

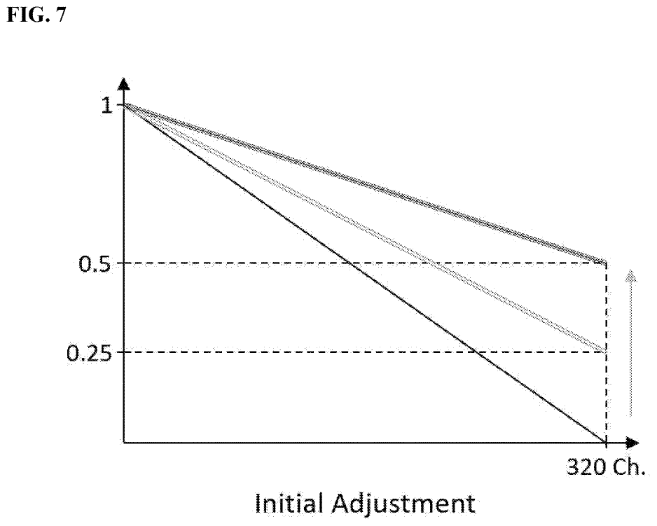

FIG. 7 illustrates an embodiment in which an alignment range is adjusted early in a channel output from SLS.

As an embodiment, the FENet of an FCTM may output 320 channels. The masking adjustment of an SLS may be performed by using a uniform distribution random variable.

Referring to FIG. 7, a solid line may be a case in which the range of n is from 0 to 319. For a solid line, the 320th channel may participate in learning with a probability of 1/320. For this method, when the learning amount (the number of learning) is small, a back channel may participate less in learning, resulting in poor learning.

An embodiment for enhancing this may be a double line and a triple line in FIG. 7.

For a double line in FIG. 7, masking may operate to output a channel from a minimum of 80 channels to a maximum of 320 channels. In this case, the first 80 channels may be learned to have the same importance and a channel aligned from the 81st channel may be output. It may be an example in which SLS strength is configured as 0.25 from the beginning.

For a triple line in FIG. 7, masking may operate to output a channel from a minimum of 160 channels to a maximum of 320 channels. In this case, the first 160 channels may be learned to have the same importance and a channel aligned from the 160th channel may be output. It may be an example in which SLS strength is configured as 0.5 from the beginning.

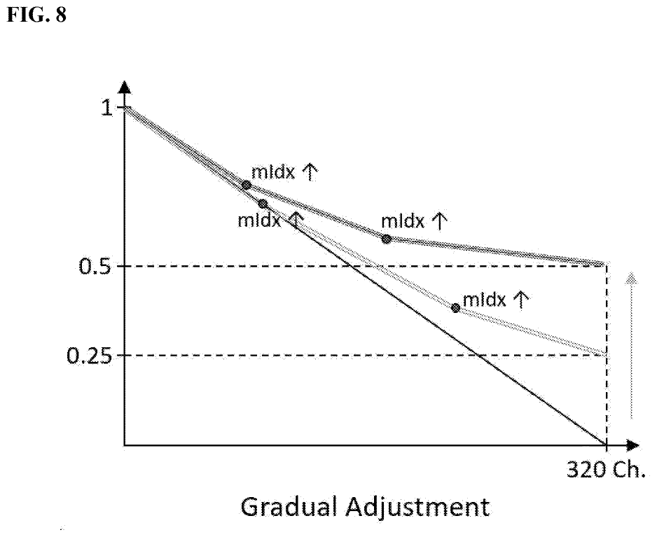

FIG. 8 is another embodiment of SLS and illustrates a method for dynamically adjusting an alignment range during a learning process.

A method for dynamically adjusting an alignment range during a learning process may be a way to more utilize the information of a higher index by dynamically adjusting masking strength performed when performing an SLS.

A solid line in FIG. 8 is a case in which the range of n is from 0 to 319, which may represent an example in which masking strength is not dynamically adjusted.

As a double line and a triple line in FIG. 8 are an example in which masking strength is dynamically adjusted, a double line in FIG. 8 may be an example in which SLS strength is gradually increased to 0.25 and a triple line in FIG. 8 may be an example in which SLS strength is gradually increased to 0.5.

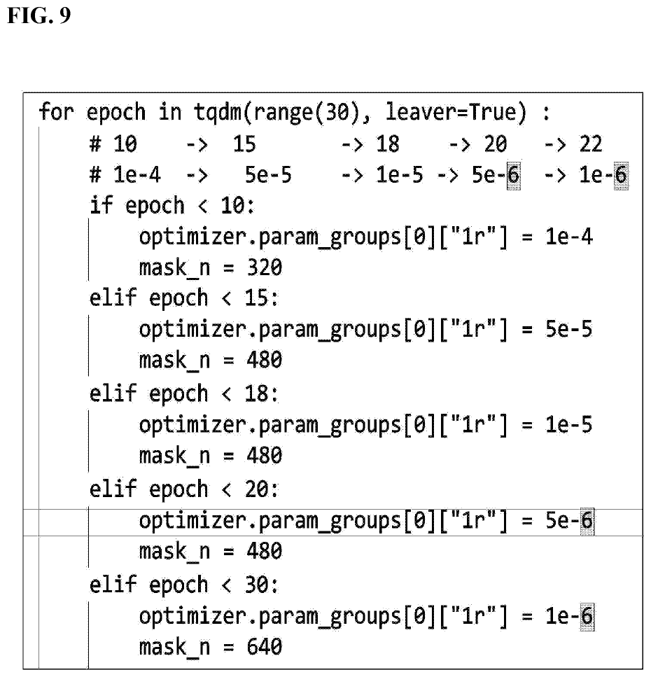

FIG. 9 illustrates an example of coding for a method for dynamically adjusting an alignment range during a learning process.

Referring to FIG. 9, an example may be confirmed in which mask_n increases per 10 epochs according to a code for decreasing a learning rate during a learning process.

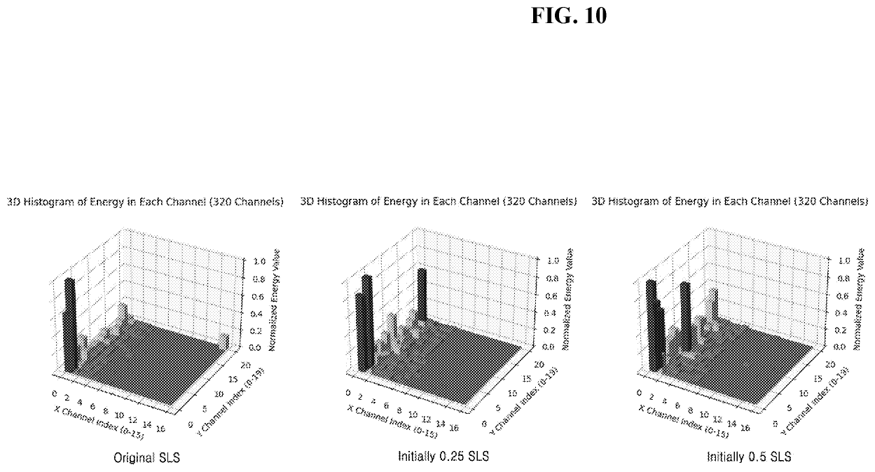

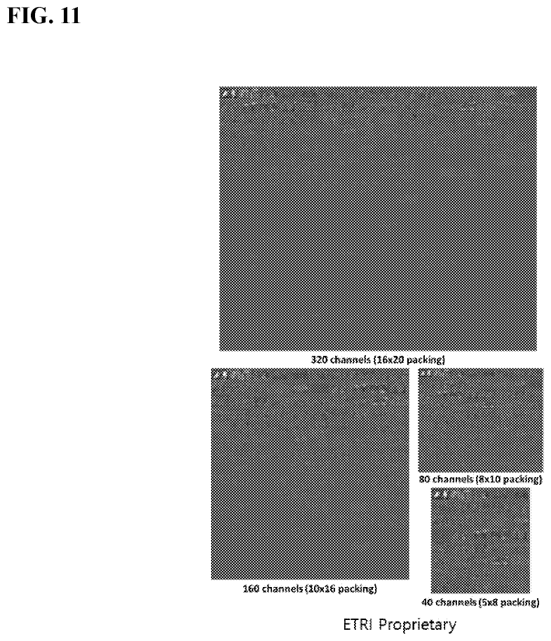

FIG. 10 is a diagram for describing the effect of embodiments in which SLS strength is adjusted early.

Referring to FIG. 10, an original SLS is an example of feature energy distribution when SLS strength is not adjusted, an initially 0.25 SLS is an example of feature energy distribution when SLS strength is adjusted early to 0.25 (a double line in FIG. 7), and an initially 0.5 SLS is an example of feature energy distribution when SLS strength is adjusted early to 0.5 (a triple line in FIG. 7).

Referring to FIG. 10, it may be confirmed that the feature energy of a higher index is relatively largely maintained even when SLS strength is lowered early.

FIG. 11 illustrates an embodiment of adaptive truncation.

An FCTM FENet to which SLS learning is applied may output 320 channels. In this case, they are aligned as shown in the case of 320 channels in FIG. 11.

An MPEG FCM group evaluates the technology through common training and test conditions (CTTC). The bit rate results of PP0, PP1, PP2 and PP3 must be presented in descending order of bit rate.

FIG. 11 is an embodiment in which PP0 uses all 320 channels, PP1 truncates the last 160 channels and uses only the first 160 channels, PP2 truncates the last 240 channels and uses only the first 80 channels and PP3 truncates the last 280 channels and uses only the first 40 channels. It may be expressed as [320,160,80,40].

As another embodiment, a truncation method may be applied differently according to a dataset and a machine task as follows.

In an embodiment in which an SLS and QACT are applied to an FCTM compression pipeline, QACT may adjust the resolution of a feature map to be encoded with VVC by removing the feature channel of a feature map rearranged according to importance by an SLS starting from a feature channel with low importance according to a given QP. Accordingly, when a compression bit rate is low, information loss may be minimized while reducing the size of a feature map to be compressed and transmitted.

When a dataset is OIV det, OIV seg or TVD trk, the number of feature channels truncated according to a QP may be expressed as [320, 160, 80, 40]. As an example, for PP0, all 320 channels may be used, and for PP1, the number of truncated feature channels may be 160, and for PP2, the number of truncated feature channels may be 80, and for PP3, the number of truncated feature channels may be 40.

When a dataset is SFU det or HiEve trk, the number of feature channels truncated according to a QP may be expressed as [320, 240, 180, 135]. As an example, for PP0, all 320 channels may be used, and for PP1, the number of truncated feature channels may be 240, and for PP2, the number of truncated feature channels may be 180, and for PP3, the number of truncated feature channels may be 135.

As an embodiment of applying additional SLS learning, instead of applying SLS learning to FENet and DRNet learning processes, in order to utilize a learned FENet and DRNet, SLS learning may also be applied under a structure where an artificial neural network (an alignment neural network) that aligns the output of an FENet in the order of importance is inserted on a feature map encoder side and an artificial neural network (an inverse alignment neural network) that restores (inversely aligns) an aligned feature in the original order is inserted on a feature map decoder side when learning is completed. The advantage of the embodiment of applying additional SLS learning is that learning complexity may be reduced because a learned FENet and DRNet are utilized. It may be because only an alignment neural network that aligns the output feature map of an FENet in the order of importance and an inverse alignment neural network in an inverse process need to be learned.

In this case, for importance, a machine learning performance measure such as mAP and mota may be used, and a distortion measure such as MSE (mean square error) and ASE (Absolute Sum Error) may be used.

In FENet/DRNet E2E (End-to-End) learning used in an FCM reference software FCTM, a loss function that considers both a rate and distortion may be used.

A loss function may be expressed as L=R+λD.

Here, R represents learning term R for a rate, and D represents learning term D for distortion.

In a selective learning strategy (SLS) method, a masking process may be applied only to the output fused feature of an FENet. The channels of a fused feature may be selected (or masked) by uniform distribution random variable n. According to this, channels from 0 to (n−1) may be activated, and the remaining channels may be masked to 0 and deactivated. A masked fused feature output in this process may be input to a DRnet. In other words, an SLS method may be considered as a method for fundamentally getting involved in the learning term D (Distortion) of an FENet/a DRNet.

In FENet/DRNet E2E learning used in the FCTM of an FCM, an embodiment of learning term R (Rate) may be expressed as the following equation.

$$bpp ( bit per pixel ) loss = {\sum }_{l ∈ li k l i h oods} \frac{{\sum }_{i , j} \{ log ( {l}_{i , j} ) \}}{- log ( 2 ) \cdot num\_pixels}$$

Here, I may be the set element (y, z) of each probability distribution (liklihoods), i and j may be the index of each probability value and num_pixles may be the total number of data pixels.

Learning term R involved by an SLS method is learning term R to which the same mask (or, a mask element) as used in learning term D is applied, and the equation may be expressed as follows.

$$bpp ( bit per pixel ) loss = {\sum }_{l ∈ li k l i h oods} \frac{{\sum }_{i , j} \{ log ( {l}_{i , j} \cdot {mask}_{i} ) \}}{- log ( 2 ) \cdot num\_pixels}$$

In summary, the SLS method of the present disclosure may include an SLS method that considers both a rate and distortion.

In the equation of the loss function L=R+λD, a value of λ may also be a variable that is changed during a learning process. A value of A may be randomly selected from pre-determined values and applied to learning as follows.

TABLE 1

| | | Distortion |
|---|---|---|
| Dataset | Lambda values (λ_{q}) | Weights (w_{L}) |
| OpenImage/ | [0.0025, 0.005, 0.0125, 0.025, 0.05, | 0.2 |
| SFU | 0.125, 0.25, 0.375] | |
| TVD | [7.5, 0.03, 0.15, 0.45, 1.25, 3.0, 7.5] | 0.33 |
| HiEve | [7.5, 0.03, 0.15, 0.45, 1.25, 3.0, 7.5] | 0.33 |

According to a dataset, the number of quality levels, distortion weights and lambda values may be different.

During a learning process, loss may be calculated by cumulative averaging a loss value calculated at each quality level (q).

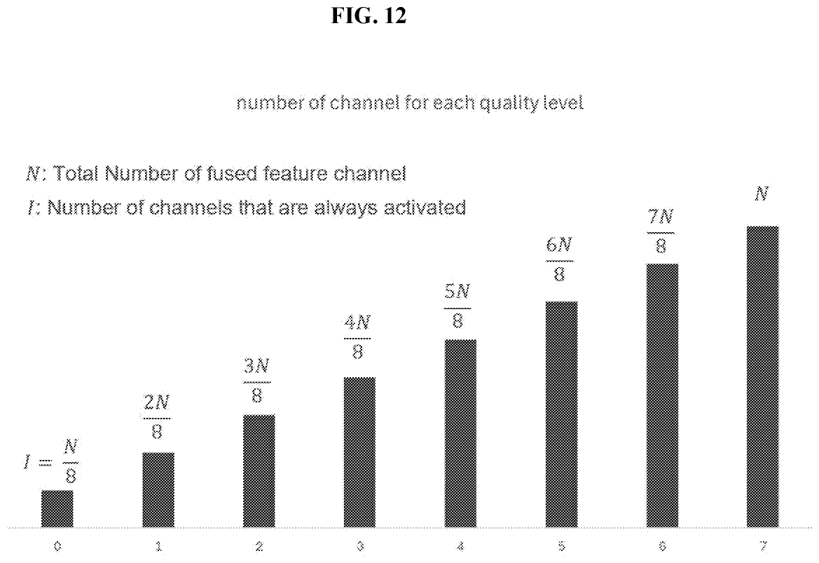

FIG. 12 illustrates an example of the number of activated channels for each quality level.

A quality level adaptive SLS may adaptively change a value of λ during a learning process.

First, a fused feature map channel from 0 to (n−1) may be activated by an SLS method, and the remaining channels may be masked to 0 and deactivated. Here, the number of channels that are always activated may be adaptively allocated to a quality level (a value corresponding to λ).

In other words, it may be

$$n = U ( I , N ) ( I ∈ [ \frac{N}{8} , … , N ] ) .$$

Here, I may increase linearly and represent the number of channels that are always activated.

In summary, an SLS may be applied adaptively to a quality level (λ).

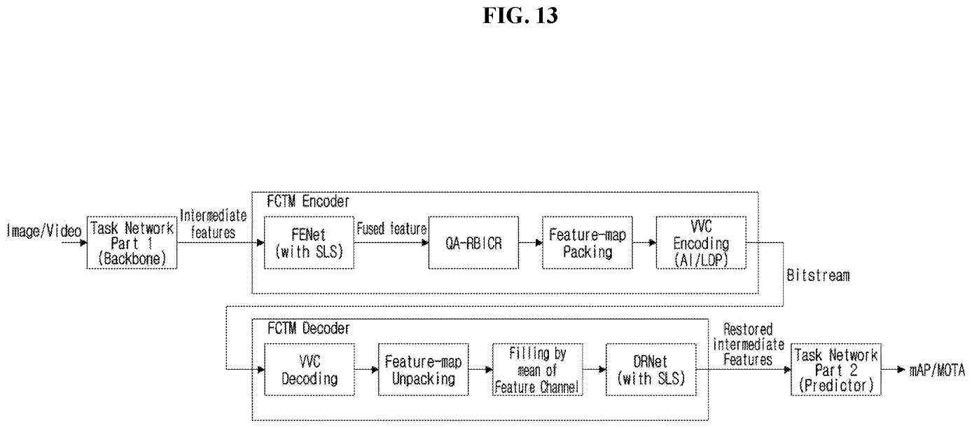

FIG. 13 illustrates an embodiment in which a channel unit feature removal technique is applied.

The RBICR (Range-Based Inactive Channel Removal) technology which is a channel unit feature channel removal technique has a problem of outputting the same channel removal result regardless of a target bitrate.

Accordingly, the present disclosure proposes the QA-RBICR (QP-Adaptive Range-Based Inactive Channel Removal) technology which is a technology for adaptively removing a channel by considering a target bitrate.

The QP-Adaptive Range-Based Inactive Channel Removal (QA-RBICR) technology may be a combination of QACT and RBICR technologies. In other words, QA-RBICR may adaptively perform RBICR on a feature map aligned in the order of importance for each channel by using a selective learning strategy (SLS) according to a given QP. QA-RBICR which utilizes an SLS may improve the spatial correlation of a compressed feature map and enable efficient feature compression by adjusting the resolution of a feature map according to a given QP.

Whether QA-RBICR is performed may be pre-defined, or may be explicitly signaled by a flag from a bitstream, or may be implicitly determined from another feature map information.

RBICR may use the feature value range of each channel (the absolute value of a difference between the maximum value and the minimum value) to classify a deactivated feature channel when the feature value of a channel is less than or equal to a specific threshold. As an example, the average of the feature value range of all feature channels configuring a feature map may be calculated, and feature channels less than or equal to a threshold based on this average value may be determined as an inactive feature channel and removed. In this case, an equation for a threshold may be configured as a value obtained by dividing an average value by 1.5 like threshold=mean(x)/1.5. Here, x may be the range values of each channel.

When QA-RBICR is performed, a method for determining the number of inactive feature channels may be determined by information on a method for determining the number of inactive feature channels signaled from a bitstream. Here, the information on a method for determining the number of inactive feature channels may be information signaled in a sequence parameter set.

As an embodiment, when information on a method for determining the number of inactive feature channels has the first value, in QA-RBICR, the number of inactive feature channels may be explicitly determined based on information representing the number of inactive feature channels signaled from a bitstream. Here, the information representing the number of inactive feature channels may be information signaled in a picture parameter set. In this case, in QA-RBICR, the number of activated feature channels may be determined based on a value obtained by subtracting the number of inactive feature channels from the total number of channels.

As an embodiment, when information on a method for determining the number of inactive feature channels has the second value, the number of inactive feature channels may be determined by determining whether each channel is inactive.

As an embodiment, QA-RBICR may adjust or determine the number of inactive feature channels by adaptively configuring a threshold according to a given target bitrate (i.e., QP, a quantization parameter).

Specifically, as a QP is higher, more feature channels may be removed, and as a QP is lower, feature channel removal may be reduced. In this case, an equation for a threshold may be the same as threshold=mean(x)/t. The equation may be adjusted to ensure that a more appropriate threshold is configured for each QP section as shown in the following table.

TABLE 2

| QP Range | t value |
|---|---|
| QP < 14 | 12 |
| 14 <= QP && QP < 19 | 6 |
| 19 <= QP && QP < 23 | 3 |
| 23 <= QP | 1.5 |

For example, a threshold may be adjusted low to t=12 to activate more feature channels in a low QP, and t=1.5 may be applied and a threshold may be configured high to remove more feature channels in a high QP.

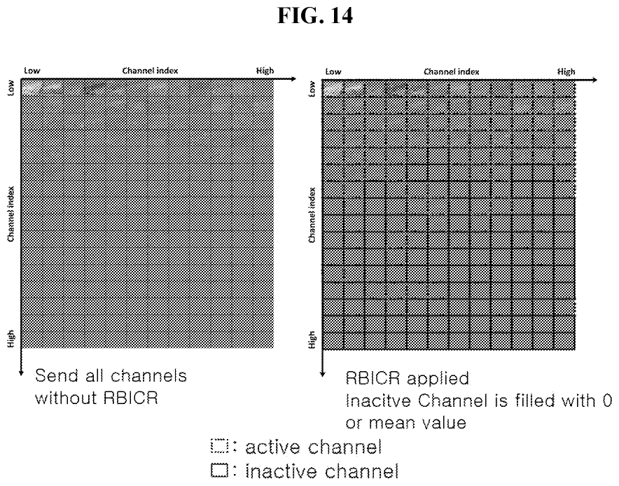

FIG. 14 is a diagram for describing the effect of applying RBICR.

The left diagram may represent that all channels are 2D frame-packed as they are when RBICR is not applied.

The right diagram indicates that RBICR is applied to distinguish between an active channel and an inactive channel, and may represent that an inactive channel is filled with 0 (zero).

As another embodiment, it may also be filled with a specific value (e.g., an average) according to 0 (instead).

When QA-RBICR is applied, distinction between an inactive channel and an active channel is changed according to an QP, which may provide an enhanced compression effect in terms of rate-performance.

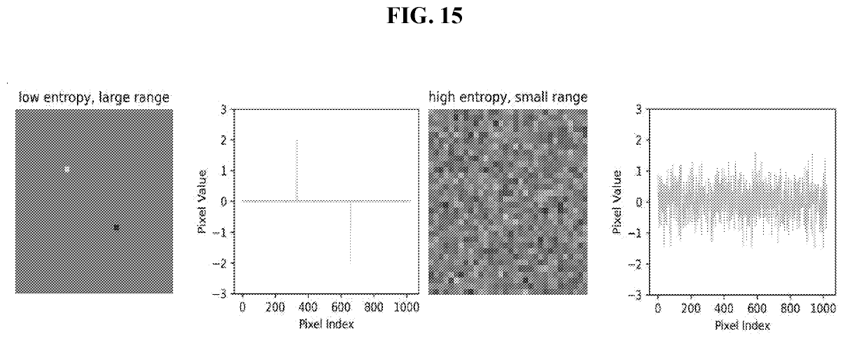

FIG. 15 is a diagram for describing the QA-RBICR technology using entropy.

A QA-RBICR technique may distinguish an inactive channel by using an average value for all channels for a feature value range corresponding to the absolute value of a difference between the maximum value and the minimum value. Active and Inactive may be considered as an important channel and an unimportant channel in terms of performance, and from this perspective, an inactive channel may be considered to be distinguished according to channel importance.

An inactive channel method based on a feature value range for each channel may have a problem that inaccurate distinction is performed when a channel has an extremely small part of the maximum value and the minimum value.

To enhance this, a method (the QA-RBICR technology using entropy) for deriving importance by using entropy to distinguish channel importance is proposed. Entropy may be obtained by quantifying how evenly feature values within a channel are distributed. A proposed method may maintain the QP adaptive threshold configuration method of QA-RBICR and substitute the average value (mean(x)) of the feature value range of all feature channels with entropy, thereby improving the preservation capability of an important channel with the large amount of information.

An equation for calculating entropy per channel may be as follows.

$$H ( c ) = - {\sum }_{i = 1}^{N} {p}_{i} log ( {p}_{i} ) , {p}_{i} = \frac{{h}_{i}}{{\sum }_{j = 1}^{N} {h}_{j}}$$

Here, H(c) may be entropy for channel c, i.e., an importance value, and pᵢ may be the probability of the i-th normalized bin in the normalized histogram of channel c.

In other words, importance H(c) represents how diverse the distribution of channel values is, and as values are widely and evenly distributed, entropy may increase and when values are distributed biased toward a specific value, entropy may decrease.

In the QA-RBICR technology using entropy, after calculating the average entropy value of all feature channels configuring a feature map, when the entropy value of an individual feature channel is less than or equal to the threshold of an equation threshold=mean(H(C))/t, it may be determined as an inactive feature channel and removed.

As an embodiment, the entropy of the present disclosure may include Shannon entropy.

Shannon entropy is an index for measuring the overall uncertainty of probability distribution, and may have a characteristic of assigning an average weight to all values.

Due to this, it insensitivity responds to information that is scare or locally concentrated within distribution, and lots of channels may show a tendency to have an average entropy value. This characteristic may cause inefficiency during a channel importance-based removal process.

To supplement this, Renyi entropy may be utilized as an importance determination index per channel. In other words, the entropy of the present disclosure may include Renyi entropy.

Renyi entropy may be generalized entropy that may adjust sensitivity to the specific characteristic of distribution through parameter a.

Renyi entropy may be expressed as shown in the following equation.

$${H}_{a} ( C ) = \frac{1}{1 - a} log ( {\sum }_{i = 1}^{n} {p}_{i}^{a} )$$

When a=1, it is the same as Shannon entropy, and when a=2, it may be interpreted as collision entropy which is more sensitive to a frequent event.

$$threshold = \frac{mean ( {H}_{a} ( c ) )}{t}$$

An FCTM may determine whether each of the 192 channels is active or inactive through the QA-RBICR technique, store it in the form of a list with false/true values and transmit it through a bitstream from an encoder side to a decoder side. However, this method may have a problem that all 192 channels must be signaled.

However, when an SLS is applied, channels are aligned in the order of importance, so active/inactive channels may be efficiently divided based on a specific index.

As the first embodiment, the amount of additional signals may be reduced by transmitting only one reference index instead of transmitting information on whether all 192 are active. In addition, even when they are a higher index channel classified as a removal target due to low importance, it may not be concluded that they include only completely meaningless information. Accordingly, a method for selectively utilizing these channels may also be considered.

When a pre-defined N % of active channels among a total of 192 channels is crowded in the front index, anchor reference point k may be configured. In this case, indexes from 0 to k may be considered active, and the remaining indexes from k+1 to 191 may be considered inactive.

As the second embodiment, the amount of additional signals may be reduced by transmitting information on one reference index and some subsequent indexes instead of transmitting information on whether all 192 are active.

When a pre-defined N % of active channels among a total of 192 channels is crowded in the front index, anchor reference point k may be configured. The remaining indexes from k+1 to 191 may be determined by the existing QA-RBICR method or may be processed by applying a certain offset.

As the third embodiment, in the embodiment, when a value of k is too small, the amount of signals may increase or inefficiency may occur, so information on whether all 192 are active may be transmitted by the existing QA-RBICR method.

For example, when at least N=90% of active channels among a total of 192 channels is crowded in the front index, reference point k=175 may be configured. In this case, indexes from 0 to 175 may be considered active (true) to transmit only an active index integer value (k=175), and the remaining indexes from 176 to 191 may be transmitted together in the form of a list where whether each channel is active is indicated as a true or false value. Accordingly, information finally transmitted to a decoder may be composed of two lists including whether integer number index k and a back index are active.

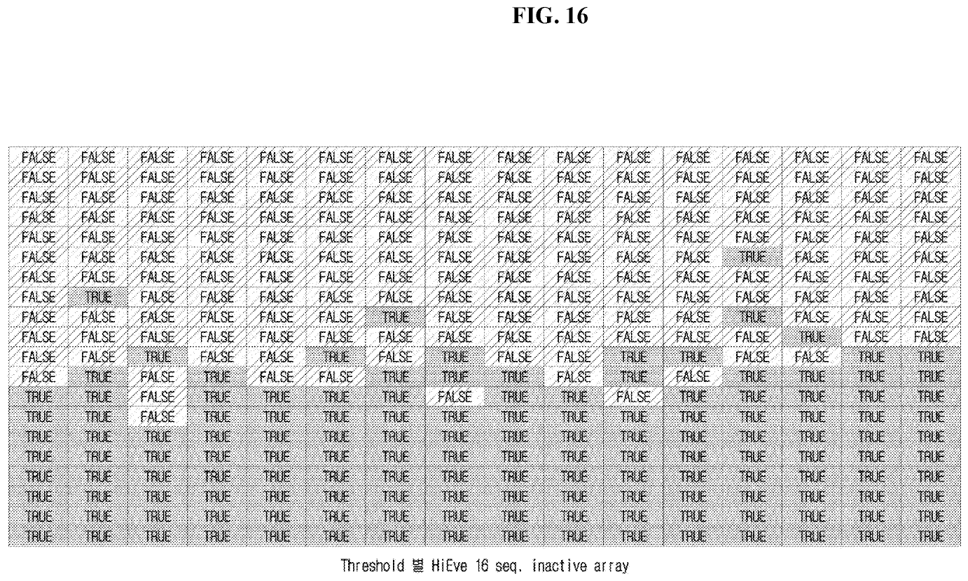

FIG. 16 illustrates an embodiment representing whether a channel is activated.

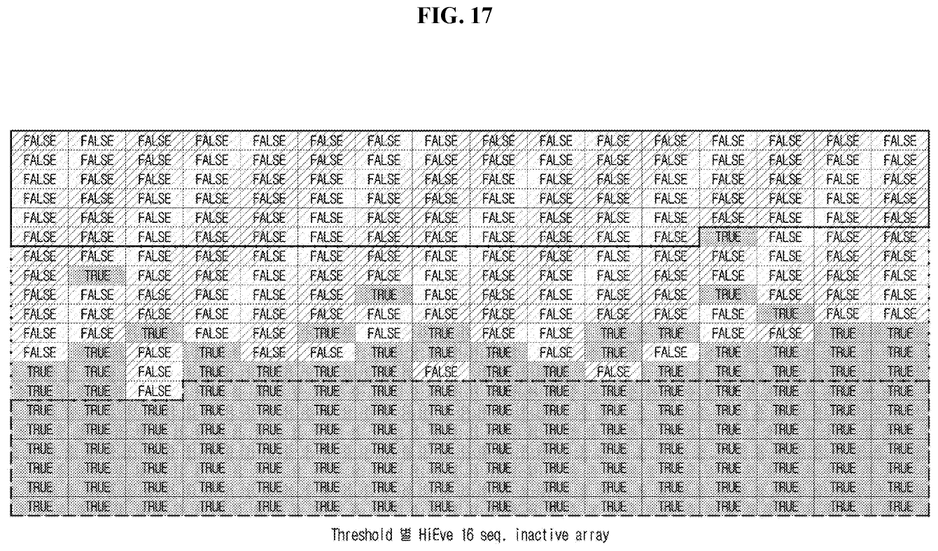

FIG. 17 illustrates an example in which a channel number section is divided.

When feature channels are arranged in raster scan order in a feature map, it may be assumed that a channel number section may be divided into the following three categories in channel number order.
a) An upper section (Section 1) with only consecutively activated channels
b) A middle section (Section 2) with a mixture of activated and inactive channels
c) A lower section (Section 3) with only consecutively inactive channels

It may be assumed that an active section starts in feature channel index 0 (the first feature ch), an inactive section exists at the end and a mixed section where active and inactive sections are mixed may exist in the middle.

In this case, the start channel index of a mixed section may be signaled, and the last ch index of a mixed section may be signaled. In this case, the end of a mixed section may signal a difference from the start.

Within a mixed section, on/off may be indicated in a channel-wise way as before.

In addition, an inactive start ch index may be indicated.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as FPGA, a GPU, other electronic device or a combination thereof. At least some of functions or processes described in illustrative embodiments of the present disclosure may be implemented by software, and software may be recorded in a recording medium. A component, a function and a process described in illustrative embodiments may be implemented by a combination of hardware and software.

A method according to an embodiment of the present disclosure may be implemented by a program which may be performed by a computer, and the computer program may be recorded in a variety of recording media such as a magnetic storage medium, an optical readout medium, a digital storage medium, etc. A method according to an embodiment of the present disclosure may be recorded on a computer-readable non-transitory recording medium.

A variety of technologies described in the present disclosure may be implemented by a digital electronic circuit, computer hardware, firmware, software or a combination thereof. The technologies may be implemented by a computer program product, i.e., a computer program tangibly implemented on an information medium or a computer program processed by a computer program (e.g., a machine readable storage device (e.g., a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language, and may be distributed in any form including a stand-alone program or module, a component, a sub-routine or other units suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and at least one processor of a digital computer. Generally, a processor receives an instruction and data in a read-only memory or a random access memory or both of them. The component of a computer may include at least one processor for executing an instruction and at least one memory device for storing an instruction and data. In addition, a computer may include at least one mass storage device for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, a ROM (Read Only Memory), a RAM (Random Access Memory), a flash memory, an EPROM (Erasable Programmable ROM), an EEPROM (Electrically Erasable Programmable ROM) and other known computer readable media. A processor and a memory may be complemented or integrated by a special-purpose logic circuit.

A processor may execute an operating system (OS) and at least one software application executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer, and may include both a computer storage medium and a transmission medium.

The present disclosure includes a detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination or the combination may be described as being initially claimed, but in some cases, at least one feature may be excluded from a claimed combination or a claimed combination may be changed in the form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments, and the above-described program component and device may be packaged into a single software product or multiple software products.

Illustrative embodiments disclosed herein are just illustrative and do not limit the scope of the present disclosure. Those skilled in the art may recognize that illustrative embodiments may be variously modified without departing from a claim and the spirit and scope of its equivalent.

Accordingly, it may be said that the present disclosure includes all other replacements, modifications and changes belonging to the following claims.

1. A feature map encoding device, comprising:
a feature reduction unit including a first artificial neural network that removes redundancy of a multi-layer feature map to output a single-layer feature map;
a feature conversion unit that converts the single-layer feature map according to an input format of a signal processing-based encoder to generate a YUV frame; and
a feature inner coding unit including the signal processing-based encoder that encodes the YUV frame to output a bitstream.

2. The device of claim 1, wherein:
a selective learning strategy is applied to the first artificial neural network, and
a flag representing whether the selective learning strategy is applied is encoded into the bitstream.

3. The device of claim 2, wherein:
when the selective learning strategy is applied, the first artificial neural network includes a channel masking block, and
the channel masking block activates or deactivates channels of a feature map through masking.

4. The device of claim 3, wherein:
a range of a channel aligned by the selective learning strategy is adjusted by a masking adjustment variable n.

5. The device of claim 4, wherein:
the range of the channel aligned by the selective learning strategy is adjusted dynamically when the selective learning strategy progresses.

6. The device of claim 4, wherein:
a part of masked channels output by a channel masking block of the first artificial neural network is truncated by a first truncation block.

7. The device of claim 6, wherein:
a degree of the truncation is determined differently according to a quantization parameter of the first artificial neural network.

8. The device of claim 1, wherein:
learning of the first artificial neural network is performed based on a loss function including a first learning term for a rate and a second learning term for distortion.

9. The device of claim 8, wherein:
a same mask element as used in the second learning term is applied to the first learning term.

10. The device of claim 9, wherein:
the loss function is calculated by cumulatively averaging a loss value calculated at each quality level, and
a number of the quality levels is different according to a dataset.

11. The device of claim 4, wherein:
a threshold that serves as a criterion for the activation or the deactivation is determined differently according to a quantization parameter of the first artificial neural network, and
the threshold is determined by using an average entropy value of the channels.

12. The device of claim 11, wherein:
the activated or deactivated channels are divided into three sections and signaled into the bitstream.

13. The device of claim 6, wherein:
according to a method for determining a number of the deactivated channels, information representing the method for determining the number of the deactivated channels is encoded into the bitstream.

14. The device of claim 13, wherein:
information representing the number of the deactivated channels is encoded into the bitstream as a parameter set different from the information representing the method for determining the number of the deactivated channels.

15. The device of claim 14, wherein:
the deactivated channel is filled with an average value of the channels.

16. A feature map decoding device, comprising:
a feature inner coding unit including a signal processing-based decoder that decodes a bitstream to obtain a restored YUV frame;
a feature inverse conversion unit that inversely converts the restored YUV frame to obtain an inversely converted single-layer feature map; and
a feature restoration unit including a second artificial neural network that outputs a restored multi-layer feature map from the inversely converted single-layer feature map.

17. The device of claim 16, wherein:
a selective learning strategy is applied to the second artificial neural network according to a flag representing whether the selective learning strategy is applied.

18. The device of claim 17, wherein:
when the selective learning strategy is applied, the second artificial neural network includes a channel masking block, and
the channel masking block activates or deactivates channels of a feature map through masking.

19. The device of claim 18, wherein:
a range of a channel aligned by the selective learning strategy is adjusted by a masking adjustment variable n.

20. A computer-readable recording medium for storing a bitstream generated by a feature map encoding method, wherein the feature map encoding method includes:
removing redundancy of a multi-layer feature map to output a single-layer feature map in a first artificial neural network of a feature reduction unit;
converting the single-layer feature map according to an input format of a signal processing-based encoder to generate a YUV frame in a feature conversion unit; and
encoding the YUV frame to output a bitstream in the signal processing-based encoder of a feature inner coding unit.
